(19) United States
(12) Patent Application Publication
(10) Pub. No.: US 2026/0192244 A1
(43) Pub. Date: Jul. 9, 2026

(54) ADSORPTION-BASED SYSTEM AND METHOD FOR CLAUS TAIL GAS TREATMENT

(71) Applicant: Saudi Arabian Oil Company, Dhahran (SA)

(72) Inventors: Hassan A. Aljama, Qatif (SA); Mohammad G. Al-Hashim, Dammam (SA); Ali A. Almofleh, Dammam (SA); Georgios Lithoxoos, Dhahran (SA)

(21) Appl. No.: 19/014,965

(22) Filed: Jan. 9, 2025

(30) Foreign Application Priority Data
Jan. 3, 2025 (GR) 20250100004

(51) Int. Cl. B01D 53/52; B01D 53/04; B01D 53/73; B01D 53/96; B01J 20/16

(52) U.S. Cl. CPC B01D 53/526; B01D 53/04; B01D 53/73; B01D 53/96; B01J 20/165; B01D 2253/108; B01D 2257/304; B01D 2257/80; B01D 2258/0283

(57) ABSTRACT

The present disclosure provides a method that includes receiving a first gas stream in a hydrogen sulfide adsorption unit, where the first gas stream comprises hydrogen sulfide and carbon dioxide. The method includes generating a first outlet stream by separating the hydrogen sulfide from the carbon dioxide with the hydrogen sulfide adsorption unit, where the hydrogen sulfide absorption unit comprises an ion-exchanged zeolite that is configured to adsorb at least a portion of the hydrogen sulfide and allow the carbon dioxide to exit the hydrogen sulfide adsorption unit via the first outlet stream. The method further includes performing a regeneration cycle on the ion-exchanged zeolite to desorb the hydrogen sulfide from the ion-exchanged zeolite, wherein during the regeneration cycle the hydrogen sulfide exits the hydrogen sulfide adsorption unit via a second outlet stream.

### CROSS-REFERENCE TO RELATED PATENT APPLICATIONS

This application claims the benefit of priority to Greek patent application No. 20250100004, filed Jan. 3, 2025, the contents of which are incorporated by reference herein.

### TECHNICAL FIELD

Embodiments of this disclosure generally relate to sulfur recovery. More specifically, embodiments of this disclosure relate to an adsorption-based system and method for Claus tail gas treatment.

### BACKGROUND

Sulfur recovery typically refers to the conversion of hydrogen sulfide to elemental sulfur. Sulfur recovery is utilized in the processing of acid gas or refining sulfur-containing crude oils. For example, acid gas typically contains natural gas as well as other gases, such as hydrogen sulfide, carbon dioxide, or a mixture of them. The conventional method of sulfur recovery in petroleum oil refineries is the Claus process, which converts hydrogen sulfide into elemental sulfur. However, the Claus process is unable to achieve a complete recovery of hydrogen sulfide due to the thermodynamic limitations of the Claus reaction. As a result, unreacted sulfur-containing compounds e.g., hydrogen sulfide and sulfur dioxide, are typically burned in an incineration unit and subsequently may be emitted into the atmosphere.

### SUMMARY

Embodiments of the present disclosure include a system and method that provide practical applications and technical advantages that address the aforementioned technical problems. Sulfur recovery units, such as the Claus process, are typically unable to achieve a complete recovery of hydrogen sulfide. The following disclosure provides a practical application of using an adsorbent to efficiently separate hydrogen sulfide from other constituents (e.g., carbon dioxide and/or water) of a tail gas stream that may be produced by a sulfur recovery unit. In some embodiments, the adsorbent comprises an ion-exchanged zeolite that selectively adsorbs hydrogen sulfide, while allowing carbon dioxide and/or water to pass through the ion-exchange zeolite, thereby efficiently separating the hydrogen sulfide from the other constituents in the tail gas stream. Once desorbed from the ion-exchanged zeolite, embodiments of the methods of the present disclosure include recycling the hydrogen sulfide back to the sulfur recovery unit so that it may be converted into elemental sulfur, thereby improving sulfur recovery of the system. The provided ion-exchanged zeolites exhibit a strong hydrogen sulfide adsorption and a weak carbon dioxide and/or water adsorption. The provided ion-exchanged zeolites may provide the technical advantage of being able to separate hydrogen sulfide from carbon dioxide and water in a single adsorption unit rather than using a two-step adsorption process (e.g., first separating water from the hydrogen sulfide and carbon dioxide in a first adsorption unit and then separating hydrogen sulfide and carbon dioxide in a second adsorption unit). Embodiments of the present disclosure that utilize a single adsorption unit provide improvements to the underlying technology by reducing capital expenditures (CapEx) and reducing operating expenditures (OpEx). Embodiments of the present disclosure further provide the technical advantage of improving sulfur recovery, e.g., from 99.0 to 99.95% or more sulfur recovery.

Aspects of the present disclosure provide a method. The method includes introducing a first gas stream to a hydrogen sulfide adsorption unit comprising an ion-exchanged zeolite, where the first gas stream comprises hydrogen sulfide and carbon dioxide. The method includes generating a first outlet stream by separating the hydrogen sulfide from the carbon dioxide with the hydrogen sulfide adsorption unit, where the ion-exchanged zeolite is configured to adsorb at least a portion of the hydrogen sulfide from the first gas stream and allow the carbon dioxide to exit the hydrogen sulfide adsorption unit via the first outlet stream. The method includes desorbing the hydrogen sulfide from the ion-exchanged zeolite using a regeneration cycle, where during the regeneration cycle the hydrogen sulfide exits the hydrogen sulfide adsorption unit via a second outlet stream.

In some embodiments, the method includes feeding the second outlet stream comprising the hydrogen sulfide to a sulfur recovery unit.

In some embodiments, the ion-exchanged zeolite comprises a cation-exchanged zeolite. For example, the ion-exchanged zeolite may be selected from an alkali metal-exchanged zeolite, an alkaline earth metal-exchanged zeolite, a transition metal-exchanged zeolite, or combinations thereof. In some embodiments, the ion-exchanged zeolite has a framework selected from LTA or CHA. In some embodiments, the ion-exchanged zeolite is selected from Ca-exchanged LTA, Sr-exchanged LTA, Ba-exchanged LTA, Na-exchanged LTA, Cu-exchanged LTA, K-exchanged LTA, or combinations thereof. In some embodiments, the ion-exchanged zeolite is selected from the group consisting of Ba-exchanged CHA, Be-exchanged CHA, or combinations thereof.

In some embodiments, the first gas steam further includes water. In some embodiments, generating the first outlet stream further comprises separating the hydrogen sulfide from the carbon dioxide and the water, wherein the ion-exchanged zeolite is configured to allow both the carbon dioxide and the water to exit the hydrogen sulfide adsorption unit via the first outlet gas stream.

In some embodiments, a water adsorption unit is positioned upstream of the hydrogen sulfide adsorption unit, and where the method further includes receiving a second gas stream in the water adsorption unit, where the second gas stream comprises hydrogen sulfide, carbon dioxide, and water. The method includes separating the water from the hydrogen sulfide and the carbon dioxide with the water adsorption unit to generate a third outlet stream comprising water and the first gas stream comprising carbon dioxide and hydrogen sulfide.

Aspects of the present disclosure provide a tail gas treatment system. The tail gas treatment system includes a hydrogen sulfide adsorption unit comprising at least one hydrogen sulfide adsorption vessel. In some embodiments, each hydrogen sulfide adsorption vessel includes one or more inlets configured to receive a gas stream that comprises hydrogen sulfide and carbon dioxide, an ion-exchanged zeolite positioned in the hydrogen sulfide adsorption vessel, where the ion-exchanged zeolite is configured to adsorb at least a portion of the hydrogen sulfide and allow the carbon dioxide to pass through the ion-exchanged zeolite, and one or more outlets configured to dispense the carbon dioxide from the hydrogen sulfide adsorption vessel during an adsorption cycle, where the one or more outlets are configured to dispense the hydrogen sulfide from the hydrogen sulfide adsorption vessel during a regeneration cycle. Each hydrogen sulfide adsorption vessel includes a first valve positioned downstream of the one or more outlets, where during the adsorption cycle the first valve is moveable to an open position to allow the carbon dioxide to pass through the first valve and exit the hydrogen sulfide unit via a first output stream, and during the regeneration cycle the first valve is movable to a closed position to restrict hydrogen sulfide from passing through the first valve to the first output stream. Each hydrogen sulfide adsorption vessel includes a second valve positioned downstream of the one or more outlets, where during the adsorption cycle the second valve is movable to a closed position to restrict the carbon dioxide from passing through the second valve to a second output stream of the hydrogen sulfide adsorption unit, and during the regeneration cycle the second valve is movable to an open position to allow the hydrogen sulfide to pass through the second valve and exit the hydrogen sulfide unit via the second output stream.

In some embodiments, the ion-exchanged zeolite comprises a cation-exchanged zeolite. For example, the ion-exchanged zeolite may be selected from an alkali metal-exchanged zeolite, an alkaline earth metal-exchanged zeolite, a transition metal-exchanged zeolite, or combinations thereof. In some embodiments, the ion-exchanged zeolite has a framework selected from LTA or CHA. In some embodiments, the ion-exchanged zeolite is selected from Ca-exchanged LTA, Sr-exchanged LTA, Ba-exchanged LTA, Na-exchanged LTA, Cu-exchanged LTA, K-exchanged LTA, or combinations thereof. In some embodiments, the ion-exchanged zeolite is selected from the group consisting of Ba-exchanged CHA, Be-exchanged CHA, or combinations thereof.

In some embodiments, the gas stream further includes water, and the ion-exchanged zeolite is configured to allow both the carbon dioxide and the water to pass through the ion-exchanged zeolite and exit the hydrogen sulfide adsorption vessel via the one or more outlet during the adsorption cycle.

In some embodiments, the tail gas treatment system further includes a water adsorption unit positioned upstream of the inlet of the hydrogen sulfide adsorption vessel, wherein the water adsorption unit comprises at least one water adsorption vessel. Each of the water adsorption vessels includes one or more inlet configured to receive the hydrogen sulfide, the carbon dioxide, and the water from a second gas stream, and an adsorbent positioned in the water adsorption vessel, the adsorbent configured to separate the water from the carbon dioxide and hydrogen sulfide. The carbon dioxide and hydrogen sulfide are configured to exit the water adsorption unit via a third output stream, where the third output stream is fed to the hydrogen sulfide adsorption unit. The water is configured to exit the water adsorption unit via a fourth output stream.

In some embodiments, the tail gas treatment system further includes a sulfur recovery unit. The sulfur recovery unit includes a first thermal stage and a second catalytic stage. The first thermal stage includes a combustion reactor configured to receive an air stream and an acid gas stream comprising hydrogen sulfide, where the combustion reactor is configured to combust the hydrogen sulfide with the oxygen in the air stream to generate a first outlet stream comprising sulfur, sulfur dioxide, water, and carbon dioxide. The first thermal stage further includes a first stage condenser positioned downstream of the combustion reactor, where the first stage condenser is configured to transfer heat between the first outlet stream and a first coolant to generate a first sulfur stream and a second outlet stream. The second catalytic stage includes at least one catalytic reactor positioned downstream of the first stage sulfur condenser, the at least one catalytic reactor including a catalyst configured to react with hydrogen sulfide and sulfur dioxide from the second outlet stream to generate a third outlet stream comprising sulfur and water. The second catalytic stage includes at least one second stage condenser positioned downstream of the at least one catalytic reactor, where the at least one second stage condenser is configured to transfer heat between the third outlet stream and a second coolant to generate a second sulfur stream and a tail gas stream comprising unreacted hydrogen sulfide, carbon dioxide, and water. The hydrogen sulfide adsorption unit is positioned downstream of the sulfur recovery unit and configured to receive the hydrogen sulfide, the carbon dioxide, and the water. The hydrogen sulfide adsorption vessel comprises a recycle stream that is in fluid communication with the second outlet of the hydrogen sulfide vessel and the combustion reactor of the sulfur recovery unit.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF THE DRAWINGS

FIG. 1 is a schematic drawing of the sulfur recovery unit according to an embodiment of the present disclosure.

FIG. 2 is a schematic drawing of a tail gas treatment system according to an embodiment of the present disclosure.

FIG. 3 is a schematic drawing of a tail gas treatment system according to an embodiment of the present disclosure.

Like reference numbers and designations in the various drawings indicate like elements.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

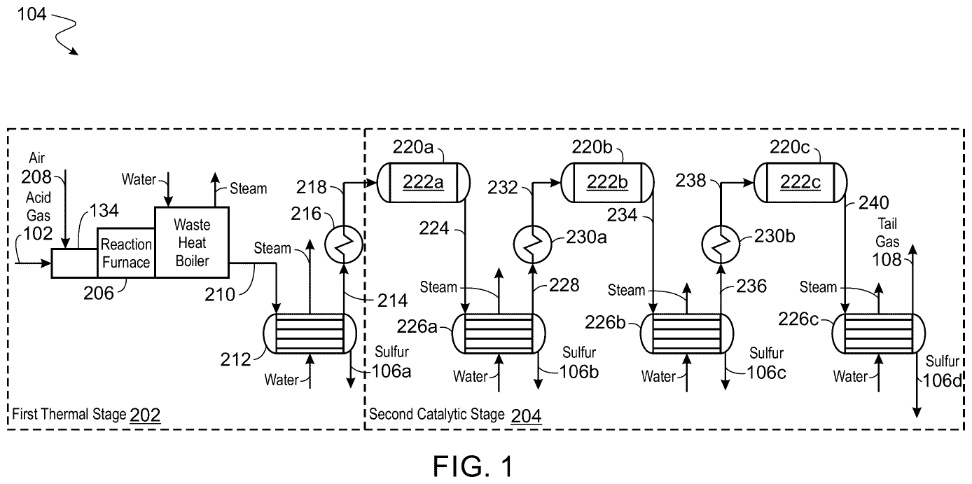

Referring to FIG. 1, a sulfur recovery unit 104 is illustrated according to some embodiments of the present disclosure. In some embodiments, the sulfur recovery unit 104 includes a first thermal stage 202 and a second catalytic stage 204. In some embodiments, the first thermal stage 202 includes a combustion reactor 206 that is configured to receive the acid gas stream 102 and an air stream 208. The combustion reactor 206 is configured to combust the hydrogen sulfide in the acid gas stream 102 with the oxygen in the air stream 208 to generate a first outlet stream 210. In some embodiments, the hydrogen sulfide reacts with oxygen to produce sulfur dioxide and water, as shown by the following chemical reaction:

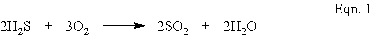

The sulfur dioxide subsequently reacts with hydrogen sulfide to produce sulfur and water, as shown by the following chemical reaction:

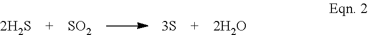

In some embodiments, the combustion reactor 206 operates at a temperature from 850° C. to 1350° C. and a pressure of 2 psig or less. In some embodiments, the combustion reactor 206 includes a waste heat boiler that is configured to transfer heat between the reaction products in the combustion reactor 206 and a coolant. In some embodiments, the coolant is water that gets converted to steam (e.g., high pressure or medium pressure steam) after transferring heat with the reaction products in the combustion reactor 206.

In some embodiments, the first thermal stage 202 further includes a first stage condenser 212 that is positioned downstream of the combustion reactor 206. The first stage condenser 212 is configured to transfer heat between the first outlet stream 210 and a coolant. In some embodiments, the coolant is water that gets converted to steam (e.g., high pressure or medium pressure steam) after transferring heat with the first output stream 210. While passing through the first stage condenser 212, the sulfur in the first output stream 210 is condensed and is removed from the first stage condenser 212 in a first sulfur stream 106a. The gases remaining in the first outlet stream 210 exit the first stage condenser 212 in a second outlet stream 214.

In some embodiments, the first thermal stage 202 further includes a first stage heater 216 that is configured to heat the second outlet stream 214 to generate a heated second outlet stream 218. The first stage heater 216 can be any heat exchanger capable of heating a gas stream. In some embodiments, the first stage heater 216 is configured to heat the second outlet stream 214 to a temperature greater than 300° C., or greater than 305° C., greater than 310° C., greater than 315° C., to less than 320° C., less than 325° C., or less than 330° C. In some embodiments, a heated second outlet stream 218 exits the first stage heater 216 and is transferred to the second catalytic stage 204.

In some embodiments, the second catalytic stage 204 includes at least one catalytic reactor 220a-220c positioned downstream of the first thermal stage 202. The catalytic reactors 220a-220c include a catalyst 222a-222c. In some embodiments, the catalyst 222a-222c is configured to react hydrogen sulfide with sulfur dioxide to generate sulfur and water, as shown in Eqn. 2 above. In some embodiments, the catalysts 222a-222c comprise an aluminum oxide catalyst or an aluminum oxide mixed with titanium oxide. In some embodiments, the heated second outlet stream 218 enters the catalytic reactor 220a and the catalyst 222a generates a third outlet stream 224 that comprises sulfur, water, as well as unreacted hydrogen sulfide and unreacted sulfur dioxide.

In some embodiments, the second catalytic stage 204 includes at least one second stage condenser 226a-226c positioned downstream of the catalytic reactor 220a. The second stage condenser 226a is configured to transfer heat between the third output stream 224 and a coolant. In some embodiments, the coolant is water that gets converted to steam (e.g., medium pressure steam) after transferring heat with the third output stream 224. While passing through the second stage condenser 226a, the sulfur in the third output stream 224 is condensed and is removed from the second stage condenser 226a as a second sulfur stream 106b. The gases remaining in the second stage condenser 226a exit the second stage condenser 226a in the fourth outlet stream 228.

In some embodiments, the second catalytic stage 204 includes a second stage heater 230a positioned downstream of the second stage condenser 226a. The second stage heater 230a is configured to heat the fourth outlet stream 228 to generate a heated fourth outlet stream 232. The second stage heater 230a can be any heat exchanger capable of heating a gas stream. In some embodiments, the second stage heater 230a is configured to heat the fourth outlet stream 228 to a temperature greater than 200° C., or greater than 220° C., greater than 240° C., to less than 260° C., less than 280° C., or less than 300° C. In some embodiments, the heated fourth outlet stream 232 exits the second stage heater 230a and is transferred to the catalytic reactor 220b.

In some embodiments, the heated fourth stream 232 enters the catalytic reactor 220b and the catalyst 222b generates a fifth outlet stream 234. For example, the catalytic reactor 220b is configured to react hydrogen sulfide with sulfur dioxide in the fourth heated stream 232 to generate sulfur and water, as shown in Eqn. 2 above. The fifth outlet stream 234 may then be transferred to the second stage condenser 226b. In some embodiments, the second stage condenser 226b is configured to transfer heat between the fifth output stream 234 and a coolant. In some embodiments, the coolant is water that gets converted to steam (e.g., medium pressure steam) after transferring heat with the fifth output stream 234. While passing through the second stage condenser 226b, the sulfur in the fifth output stream 234 is condensed and is removed from the second stage condenser 226b as a third sulfur stream 106c. The gases remaining in the second stage condenser 226b exit the second stage condenser 226b in a sixth outlet stream 236.

In some embodiments, the second catalytic stage 204 includes a second stage heater 230b positioned downstream of the second stage condenser 226b. The second stage condenser 226b is configured to heat the sixth outlet stream 236 to generate a heated sixth outlet stream 238. The second stage heater 230b can be any heat exchanger capable of heating a gas stream. In some embodiments, the second stage heater 230b is configured to heat the sixth outlet stream 236 to a temperature greater than 180° C., or greater than 200° C., greater than 220° C., to less than 240° C., or less than 260° C. In some embodiments, the heated fourth outlet stream 232 exits the second stage heater 230a and is transferred to the catalytic reactor 220c.

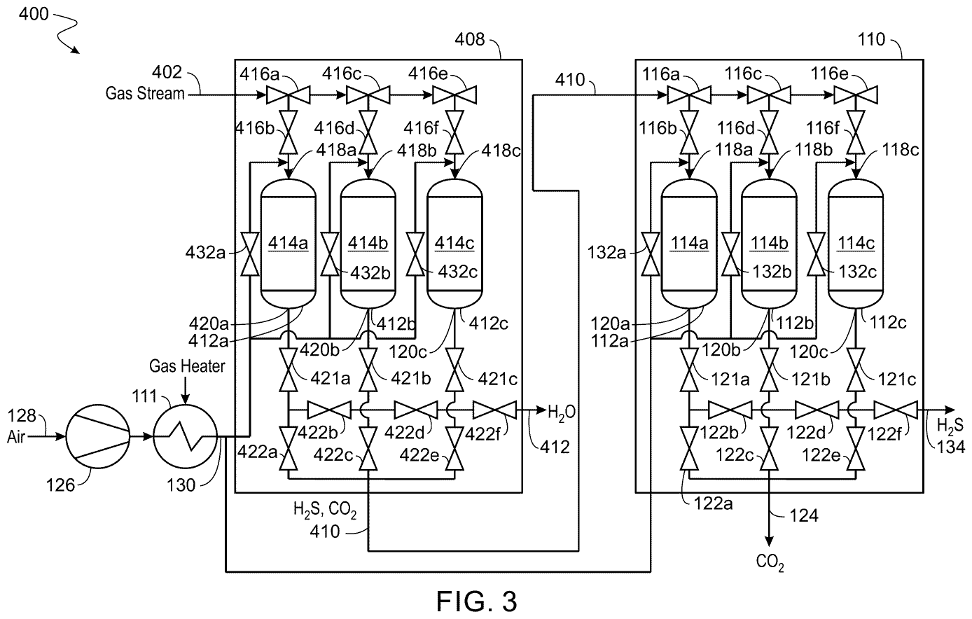

In some embodiments, the heated sixth stream 238 enters the catalytic reactor 220c and the catalyst 222c generates a seventh outlet stream 240. For example, the catalytic reactor 220c is configured to react hydrogen sulfide with sulfur dioxide in the sixth heated stream 238 to generate sulfur and water, as shown in Eqn. 2 above. The seventh outlet stream 240 may then be transferred to the second stage condenser 226c. In some embodiments, the second stage condenser 226c is configured to transfer heat between the seventh output stream 240 and a coolant. In some embodiments, the coolant is water that gets converted to steam (e.g., medium pressure steam) after transferring heat with the seventh output stream 240. While passing through the second stage condenser 226c, the sulfur in the seventh output stream 240 is condensed and is removed from the second stage condenser 226c as a fourth sulfur stream 106d. The sulfur streams 106a-106d may be combined and may exit the sulfur recovery unit 104 as the sulfur stream 106 shown in FIG. 3. The gases remaining in the second stage condenser 226c exit the second stage condenser 226c in the tail gas stream 108.

Although FIG. 1 illustrates three catalytic reactors 220a-220c, in one exemplary embodiment, the sulfur recovery unit 104 includes two catalytic reactors 220a-220b, where the sixth outlet stream 236 becomes the tail gas stream 108. In some embodiments, the sulfur recovery unit 104 with two catalytic reactors 220a-220b obtains a sulfur recovery efficiency of 90% to 97%, while a sulfur recovery unit 104 with three catalytic reactors 220a-220c obtains a sulfur recovery efficiency of 95% to 98%. The sulfur recovery unit 104 is unable to achieve a complete recovery of the hydrogen sulfide due to thermodynamic limitations. As a result, the tail gas stream 108 comprises unreacted hydrogen sulfide as well as other constituents (e.g., carbon dioxide and/or water).

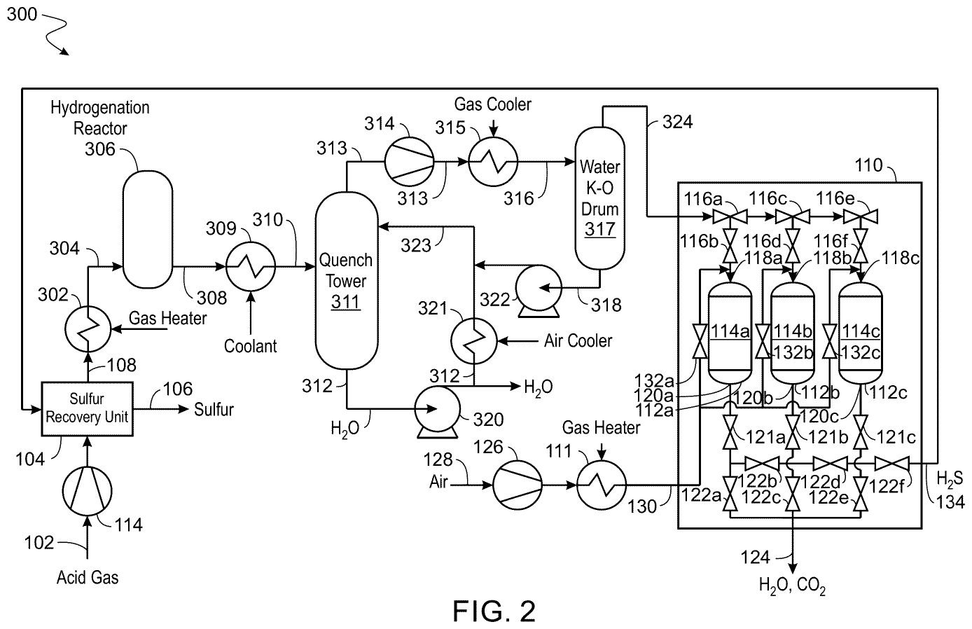

FIG. 2 illustrates a tail gas treatment system 300 according to an embodiment of the present disclosure. In general, the tail gas treatment system 300 includes the sulfur recovery unit 104, a hydrogen sulfide adsorption unit 110, a heater 111, a first compressor 114, a second compressor 126, a second heater 302, a hydrogenation reactor 306, a heat exchanger 309, a quench tower 311, a third compressor 314, a second heat exchanger 315, a water knockout drum 317, a first pump 320, an air cooler 321, and a second pump 322. In some embodiments, the tail gas treatment system 300 includes an acid gas stream 102 that is fed to the sulfur recovery unit 104 by the compressor 114. In some embodiments, the acid gas stream 102 comprises natural gas as well as other constituents. For example, the other constituents may include, but are not limited to, sulfur containing compounds (e.g., hydrogen sulfide), carbon dioxide, and water. In general, the sulfur recovery unit 104 is configured to remove sulfur from the acid gas stream 102. More specifically, the sulfur recovery unit 104 is configured to convert the acid gas stream 102 into a sulfur stream 106 and the tail gas stream 108.

In some instances, the tail gas stream 108 comprises sulfur-containing compounds other than hydrogen sulfide. For example, the tail gas stream 108 may include sulfur oxides and anionic counterparts of the same, which may include, but are not limited to, SO, SO₂, SO₃, SO₄, S₂O, S₂O₂, S₆O, S₆O₂, S₇O, S₇O₂, S₈O, S₉O, and S₁₀O. To further increase sulfur recovery, it may be beneficial to hydrogenate the sulfur oxides to hydrogen sulfide using the tail gas treatment system 300. In some embodiments, the heater 302 is positioned downstream of the sulfur recovery unit 104. In some embodiments, the heater 302 is configured to receive the tail gas stream 108 from the sulfur recovery unit 104. The heater 302 can be any heat exchanger capable of heating a gas stream to a temperature at which hydrogenation reactions occur in the hydrogenation reactor 306. In some embodiments, the heater 302 can heat the tail gas stream 108 to generate a hot gas stream 304 that has a temperature between about 200° C. and about 300° C., alternately between about 220° C. and about 280° C., and alternately between about 240° C. and about 260° C. In at least one embodiment, the temperature of the hot gas stream 304 is about 250° C. The hot gas stream 304 can include the sulfur-containing compounds, carbon dioxide, water, or combinations thereof.

The hydrogenation reactor 306 is positioned downstream of the heater 302 and configured to receive the hot gas stream 304. The hydrogenation reactor 306 can be any reactor, catalytic or non-catalytic, capable of converting the sulfur-containing compounds other than hydrogen sulfide to hydrogen sulfide in the hydrogenated gas stream 308. In some embodiments, hydrogen included in the hot gas stream 304 is used for converting the sulfur-containing compounds to hydrogen sulfide. In some embodiments, a make-up hydrogen gas stream (not shown) is introduced into the hydrogenation reactor 306. In some embodiments, water is produced as a byproduct during the hydrogenation reaction.

A heat exchanger 309 is positioned downstream of the hydrogenation reactor 306. In some embodiments, the heat exchanger 309 is configured to cool the hydrogenated gas stream 308 by transferring heat with a coolant passing through the heat exchanger 309. In some embodiments, the heat exchanger 309 is a waste heat exchanger. In some embodiments, the heat exchanger 309 cools the hydrogenated gas stream 308 to generate a cooled hydrogenated gas stream 310 having a temperature in a range from about 100° C. to about 200° C., or from about 150° C., to about 170° C.

The quench tower 311 is positioned downstream of the heat exchanger 309 and configured to receive the cooled hydrogenated gas stream 310. The quench tower 311 can be any apparatus capable of condensing and recovering water. A substantial portion of water included in the cooled hydrogenated gas stream 310 is condensed and substantially recovered via the water condensate stream 312. Although a substantial portion of water included in the cooled hydrogenated gas stream 310 is removed via the water condensate stream 312, the resulting quenched gas stream 313 can still include residual amounts of gas phase water. The quenched gas stream 313 has a gas phase water content ranging between about 0 mol % and about 20 mol %, alternately between about 3 mol % and about 15 mol %, or alternately between about 4 mol % and about 10 mol %. In at least one embodiment, the gas phase water content of the quenched gas stream 313 is about 8 mol %. The quenched gas stream 313 also includes hydrogen sulfide, carbon dioxide, or combinations of the same. The quenched gas stream 313 has a temperature ranging between about 20° C. and about 170° C., alternately between about 30° C. and about 100° C., or alternately between about 40° C. and about 80° C. In at least one embodiment, the temperature of the quenched gas stream 313 is about 43° C.

A first pump 320 is positioned downstream of the quench tower 311 and configured to receive the water condensate stream 312. The first pump 320 is configured to remove water from the quench tower 311 via the water condensate stream 312. In some embodiments, a portion of the water condensate stream 312 is transported via the first pump 320 to a sour gas water stripper (not shown). In some embodiments, a portion of the water condensate 312 exiting the first pump 320 is received by an air cooler 321. The air cooler 321 can be any heat exchanger capable of cooling the water condensate stream 312. In some embodiments, the air cooler 321 is configured to cool the water condensate stream 312 to a temperature from about 20° C. to about 100° C.

A compressor 314 is positioned downstream of the quench tower 311 and configured to receive the quenched gas stream 313. In some embodiments, the compressor 314 is configured to transport the quenched gas stream 313 to a second heat exchanger 315. The second heat exchanger 315 can be any heat exchanger capable of cooling a gas stream to a temperature at which adsorption occurs in the hydrogen sulfide adsorption unit 110 or the second adsorption unit 408. The second heat exchanger 315 can cool the quenched gas stream 313 such that a cool gas stream 316 has a temperature ranging between about 0° C. and about 70° C., alternately between about 10° C. and about 40° C., and alternately between about 15° C. and about 30° C. In at least one embodiment, the temperature of the cool gas stream 316 is about 21° C. As the quenched gas stream 313 is cooled, the gas phase water content of the cool gas stream 316 reduces to a range between about 0 mol % and about 10 mol %, alternately between about 0 mol % and about 5 mol %, or alternately between about 0 mol % and about 1 mol %. In at least one embodiment, the gas phase water content of cool gas stream 316 is about 0.46 mol %. The cool gas stream 316 can include hydrogen sulfide carbon dioxide, water, or combinations of the same.

The cool gas stream 316 is received by a water knockout (KO) drum 317. The water KO drum 317 is configured to separate water from the gases in the cool gas stream 316. In some embodiments, the water KO drum 317 uses gravitational separation to further remove water from the cool gas stream 316, where the water exits the water KO drum 317 via a water condensate stream 318. A second pump 322 is configured to receive the water condensate stream 318 and is configured to combine the water in the water condensate stream 318 with the water exiting the air cooler 321 to generate a combined water condensate stream 323. The combined water condensate stream 323 is returned to the quench tower 311, e.g., an upper portion of the quench tower 311. In some embodiments, a gas stream 324 exiting the water KO drum 317 is received by the hydrogen sulfide adsorption unit 110 (as shown in FIG. 2) or the second adsorption unit 408 (as shown in FIG. 3).

The gas stream 324 may be received by the hydrogen sulfide adsorption unit 110. In some embodiments, the hydrogen sulfide adsorption unit 110 is configured to generate an outlet stream 124 comprising water and carbon dioxide and the outlet stream 134 comprising hydrogen sulfide. In some embodiments, the hydrogen sulfide adsorption unit 110 comprises one or more hydrogen sulfide adsorption vessels 112a-112c that are configured to receive constituents of the gas stream 324 (e.g., a gas stream that comprises hydrogen sulfide, carbon dioxide, and optionally water). The hydrogen sulfide adsorption unit 110 may include one or more valves 116a-116f positioned upstream of the hydrogen sulfide adsorption vessels 112a-112c. The one or more valves 116a-116f are configured to control the flow of the gas stream 324 to a respective inlet 118a-118c of the hydrogen sulfide adsorption vessels 112a-112c.

The hydrogen sulfide adsorption unit 110 may include one or more valves 121a-121c and 122a-122f positioned downstream of the hydrogen sulfide adsorption vessels 112a-112c. The one or more valves 122a-122f and valves 121a-121c are configured to control the flow of gases exiting a respective outlet 120a-120c of the hydrogen sulfide adsorption vessels 112a-112c. The hydrogen sulfide adsorption vessels 112a-112c may be connected in series or parallel. Each of the hydrogen sulfide adsorption vessels 112a-112c comprise one or more adsorbents 114a-114c. In some embodiments, the one or more adsorbents 114a-114c are configured to adsorb hydrogen sulfide while allowing carbon dioxide and/or water, as well as other constituents in the gas stream, to pass through the adsorbents 114a-114c.

In some embodiments, the absorbents 114a-114c comprise an ion-exchanged zeolite, such as a cation-ion exchanged zeolite. For example, the cation-exchanged zeolite may be selected from an alkali metal-exchanged zeolite, an alkaline earth metal-exchanged zeolite, a transition metal-exchanged zeolite, or a combination thereof. In some non-limiting examples, the ion-exchanged zeolite includes, but is not limited to, a Ca-exchanged zeolite, a Sr-exchanged zeolite, a Ba-exchanged zeolite, a Na-exchanged zeolite, a Cu-exchanged zeolite, a K-exchanged zeolite, a Ba-exchanged zeolite, a Be-exchanged zeolite, or combinations thereof.

In some embodiments, the ion-exchanged zeolite comprises a Linde Type A (LTA) framework or a Chabazite (CHA) framework. In some embodiments, the ion-exchange zeolite comprises a cation-exchanged LTA zeolite, a cation-exchanged CHA framework, or a combination thereof. In some non-limiting examples, the ion-exchanged zeolite includes, but is not limited to, a Ca-exchanged LTA, a Sr-exchanged LTA, a Ba-exchanged LTA, a Na-exchanged LTA, a Cu-exchanged LTA, a K-exchanged LTA, or combinations thereof. In other non-limiting examples, the ion-exchanged zeolite includes, but is not limited to, a Ba-exchanged CHA, a Be-exchanged CHA, or combinations thereof.

In some embodiments, the hydrogen sulfide adsorption unit 110 includes at least three hydrogen sulfide adsorption vessels 112a-112c positioned in parallel. During operation, one of the at least three hydrogen sulfide adsorption vessels 112a-112c may be operating in an adsorption cycle, one of the at least three hydrogen sulfide adsorption vessels 112a-112c may be operating in a regeneration cycle, and one of the at least three hydrogen sulfide adsorption vessels 112a-112c may be operating in a standby cycle. In this manner, a continuous flow of the tail gas stream 108 can be fed to the hydrogen sulfide adsorption unit 110 and a continuous flow of the first output stream 124 and the second output stream 134 can be produced.

To illustrate the operation, the following describes an example method of using the tail gas treatment system 300, where the hydrogen sulfide adsorption vessel 112a is in an adsorption cycle, the hydrogen sulfide adsorption vessel 112b is in a regeneration cycle, and the hydrogen sulfide adsorption vessel 112c is in a standby cycle. In this example, constituents of the gas stream 324 are fed to the inlet 118a of the hydrogen sulfide adsorption vessel 112a. Valves 116a-116b are in the open position to allow the constituents of the tail gas stream 108 to be received by the inlet 118a of the hydrogen sulfide adsorption vessel 114a. Valves 116c-116f are in the closed position to restrict, or otherwise prevent, the flow of constituents in the gas stream 324 to hydrogen sulfide adsorption vessels 112b-112c. The adsorbent 114a in hydrogen sulfide adsorption vessel 112a is configured to adsorb the hydrogen sulfide in the gas stream 324 while allowing the carbon dioxide and/or water, as well as other constituents in the gas stream 324, to pass through the adsorbent 114a. Constituents of the gas stream 324 that are not adsorbed by the adsorbent 114a are dispensed from the hydrogen sulfide adsorption vessel 112a via the outlet 120a.

During the adsorption cycle, valve 121a and valve 122a are in the open position to allow the constituents dispensed from the outlet 120a to exit the hydrogen adsorption unit 110 via a first outlet stream 124. In some embodiments, the first outlet stream 124 comprises carbon dioxide and/or water. While the hydrogen sulfide adsorption vessel 114a operates in the adsorption cycle, valve 122b is in the closed position to restrict, or otherwise prevent, the constituents exiting the outlet 120a from passing through the valve 122b to the second outlet stream 134.

While the hydrogen sulfide adsorption vessel 112a operates in the adsorption cycle, the hydrogen sulfide adsorption vessel 112b may operate in a regeneration cycle to remove previously adsorbed hydrogen sulfide. During the regeneration cycle valves 116c and 116d are in a closed position to restrict, or otherwise prevent, constituents form the tail gas stream 108 from entering the inlet 118b of the hydrogen sulfide adsorption vessel 112b. During the regeneration cycle, hydrogen sulfide is desorbed from the absorbent 114b. For example, a regenerative gas stream 130 may be heated to a temperature that desorbs the hydrogen sulfide from the adsorbent 114b to regenerate the adsorbent 114b.

In some embodiments, the heater 111 may be configured to heat the air stream 128 to produce the regenerative gas stream 130. The heater 111 can be any heat exchanger capable of heating a gas stream to a temperature that desorbs the hydrogen sulfide from the adsorbents 114a-114c. The heater 111 can heat the air feed 128 such that the regeneration gas stream 130 has a temperature between about 150° C. and about 350° C., alternately between about 200° C. and about 300° C., and alternately between about 230° C. and about 290° C. In one embodiment, the temperature of the regeneration gas stream 130 is about 260° C.

In some embodiments, valve 132a-132c may be positioned upstream of the respective inlets 118a-118c of the hydrogen sulfide adsorption vessels 112a-112c, where the valves 132a-132c are configured to control the flow rate of the regenerative gas stream 130. In the preceding example, the valve 132b is moved to an open position to allow the regenerative gas stream 130 to enter the hydrogen sulfide adsorption vessel 112b via the inlet 118b to contact the adsorbent 114b and desorb the hydrogen sulfide from the absorbent 114b. During the regeneration cycle, valve 121b and valve 122d may be moved to the open position to allow the desorbed hydrogen sulfide to pass through valve 121b and valve 122d to exit the hydrogen sulfide unit 110 via the second outlet stream 134. Valve 122c may be moved to a closed position to restrict, or otherwise prevent, the desorbed hydrogen sulfide from passing through valve 122c and exiting the hydrogen sulfide adsorption unit 110 via the first output stream 124. In some embodiments, the second outlet stream 134 comprising the hydrogen sulfide is recycled back to the sulfur recovery unit 104 for further processing. Recycling the hydrogen sulfide back to the sulfur recovery unit 104 improves sulfur recovery efficiency, e.g., from 99.95 to 99.99% or more sulfur recovery.

While the hydrogen sulfide vessel 112a operates in an adsorption cycle and the hydrogen sulfide vessel 112b operates in the regeneration cycle, the hydrogen sulfide vessel 112c may operate in a standby cycle. While operating in the standby cycle, valves 116e-116 are closed to restrict, or otherwise prevent, the flow of the tail gas stream 108 to the hydrogen sulfide vessel 112c. Valves 121c, 122e, and 132c are moved to the closed position to isolate the adsorbent 114c within the hydrogen sulfide adsorption vessel 112c. The hydrogen sulfide vessel 112c may remain in the standby mode until it is needed (e.g., maintenance needs to be performed on hydrogen sulfide vessels 112a-112b or the adsorbent 114a-114c needs to be replaced).

Once the adsorbent 114a has reached its adsorption capacity or a pre-determined adsorption timer has elapsed, the hydrogen sulfide adsorption vessel 112a may be transitioned from the adsorption cycle to a regeneration cycle. To transition from the adsorption cycle to the regeneration cycle, valves 116a and 116b are moved to the closed position to restrict, or otherwise prevent, the flow of the tail gas stream 108 to the hydrogen sulfide vessel 112a, and valve 132a is opened to allow the regenerative gas stream 130 to enter the hydrogen sulfide adsorption vessel 112a and desorb the hydrogen sulfide from the adsorbent 114a. Further, during the transition, valve 122a is closed to restrict, or otherwise prevent, desorbed hydrogen sulfide from exiting the hydrogen sulfide adsorption unit 110 via the first output stream 124, and valve 122b is moved to the open position to allow desorbed hydrogen sulfide to exit the hydrogen sulfide adsorption unit 110 via the second output stream 134.

Once the adsorbent 114b has been regenerated or a pre-determined regeneration timer has elapsed, the hydrogen sulfide adsorption vessel 112b may be transitioned form the regeneration cycle to the adsorption cycle. To transition from the regeneration cycle to the adsorption cycle, valve 116c and valve 116d may be moved to the open position to allow the tail gas stream 108 to enter the inlet 118b of the hydrogen sulfide adsorption vessel 112b, and valve 132b may be moved to the closed position to restrict, or otherwise prevent, the regeneration gas stream 130 from entering the inlet 118b. The adsorbent 114b in hydrogen adsorption vessel 112b is configured to adsorb the hydrogen sulfide in the tail gas stream 108 while allowing the carbon dioxide and/or water, as well as other constituents in the tail gas stream 108, to pass through the adsorbent 114b. Constituents of the tail gas stream 108 that are not adsorbed by the adsorbent 114b are dispensed from the hydrogen sulfide adsorption vessel 112b via the outlet 120b. During the transition, valve 122d may be moved to the closed position to restrict, or otherwise prevent, constituents exiting the outlet 120b from passing through valve 122d and to the second output stream 134. During the transition, valve 122c may be moved to the open position to allow the constituents exiting the outlet 120b to pass through the valve 122c to the first output stream 124. In some embodiments, the first output stream 124 comprises water and/or carbon dioxide.

Referring to FIG. 3, a tail gas treatment system 400 is illustrated according to an embodiment of the present disclosure. In some embodiments, the tail gas treatment system 400 includes the same components as the tail gas system 300 but further includes a second adsorption unit 408 positioned upstream of the hydrogen sulfide adsorption unit 110. In some embodiments, the second adsorption unit 408 is configured to receive a first gas stream 402 that comprises hydrogen sulfide, carbon dioxide, and water. In some embodiments, the first gas stream is the gas stream 324 from FIG. 2.

In this exemplary embodiment, the second adsorption unit 408 includes adsorbents 414a-414c, which are configured to adsorb water and allow hydrogen sulfide and carbon dioxide to pass through the adsorbents 414a-414c in the adsorption cycle. In this configuration, the second adsorption unit 408 is configured to generate an output stream 410 that comprises hydrogen sulfide and carbon dioxide, as well as an output stream 412 that comprises water.

The second adsorption unit 408 comprises one or more second adsorption vessels 412a-412c that are configured to receive constituents of the first gas stream 402. The second adsorption unit 408 may include one or more valves 416a-416f positioned upstream of the second adsorption vessels 412a-412c. The one or more valves 416a-416f are configured to control the flow of the first gas stream 402 to a respective inlet 418a-418c of the second adsorption vessels 412a-412c.

The second adsorption unit 408 may include one or more valves 421a-421c and valves 422a-422f positioned downstream of the second adsorption vessels 412a-412c. The one or more valves 422a-422f and valves 421a-421c are configured to control the flow of gases exiting a respective outlet 420a-420c of the second adsorption vessels 412a-412c. The second adsorption vessels 412a-412c may be connected in series or parallel. Each of the second adsorption vessels 412a-412c comprise one or more adsorbents 414a-414c.

In some embodiments, the one or more adsorbents 414a-414c are configured to adsorb water while allowing carbon dioxide and hydrogen sulfide to pass through the absorbents 414a-414c. In some embodiments, the one or more adsorbents 414a-414c are configured to selectively capture water while allowing hydrogen sulfide and carbon dioxide to pass through the adsorbents 414a-414c. Non-limiting examples include hydrophilic 3 Å molecular sieves, such as zeolite-3A. Zeolite-3A has a pore diameter of about 3 Å, which may adsorb water, but does not adsorb carbon dioxide or hydrogen sulfide.

In some embodiments, the second adsorption unit 408 includes at least three second adsorption vessels 412a-412c positioned in parallel. During operation, one of the at least three second adsorption vessels 412a-412c may be operating in an adsorption cycle, one of the at least three second adsorption vessels 412a-412c may be operating in a regeneration cycle, and one of the at least three second adsorption vessels 412a-412c may be operating in a standby cycle. In this manner, a continuous flow of the third outlet stream 410 and the fourth outlet stream 412 can be produced.

To illustrate the operation, the following describes an example method of using the tail gas treatment system 400, where the second adsorption vessel 412a is in an adsorption cycle, the second adsorption vessel 412b is in a regeneration cycle, and the second adsorption vessel 412c is in a standby cycle. In this example, constituents of the first gas stream 402 are fed to the inlet 418a of the second adsorption vessel 412a. Valves 416a-416b are in the open position to allow the constituents of the first gas stream 402 to be received by the inlet 418a of the second adsorption vessel 414a. Valves 416c-416f are in the closed position to restrict, or otherwise prevent, the flow of constituents in the outlet gas stream 410 to second adsorption vessels 412b-412c.

Constituents that are not adsorbed by the adsorbent 414a are dispensed from the second adsorption vessel 412a via the outlet 420a. During the adsorption cycle, valve 421a and valve 422a are in the open position to allow the constituents dispensed from the outlet 420a to exit the second adsorption unit 408 via the outlet stream 410. When the adsorbent 414a adsorbs water, the third outlet stream 410 comprises carbon dioxide and hydrogen sulfide. While the second adsorption vessel 414a operates in the adsorption cycle, valve 422b is in the closed position to restrict, or otherwise prevent, the constituents exiting the outlet 420a from passing through the valve 422b to the outlet stream 412.

While the second adsorption vessel 412a operates in the adsorption cycle, the second adsorption vessel 412b may operate in a regeneration cycle to remove previously adsorbed constituents. During the regeneration cycle valves 416c and 416d are in a closed position to restrict, or otherwise prevent, constituents form the outlet gas stream 410 from entering the inlet 418b of the second adsorption vessel 412b. During the regeneration cycle, adsorbed constituents are desorbed from the absorbent 414b. For example, a regenerative gas stream 130 may be heated to a temperature that desorbs the constituents from the adsorbent 414b to regenerate the adsorbent 414b.

In some embodiments, the heater 111 is configured to heat the air stream 128 to produce the regenerative gas stream 130. The heater 111 can be any heat exchanger capable of heating a gas stream to a temperature that desorbs the water from the adsorbents 414a-414c. The heater 111 can heat the air feed 128 such that the regeneration gas stream 130 has a temperature between about 150° C. and about 350° C., alternately between about 200° C. and about 300° C., and alternately between about 230° C. and about 290° C. In one embodiment, the temperature of the regeneration gas stream 130 is about 260° C.

In some embodiments, valves 432a-432c are positioned upstream of the respective inlets 418a-418c of the second adsorption vessels 412a-412c, where the valves 432a-432c are configured to control the flow rate of the regenerative gas stream 130. In the preceding example, the valve 432b is moved to an open position to allow the regenerative gas stream 130 to enter the second adsorption vessel 412b via the inlet 418b to contact the adsorbent 414b and desorb the constituents from the absorbent 414b. During the regeneration cycle, valve 421b and valve 422d may be moved to the open position to allow the desorbed constituents to pass through valve 421b and valve 422d to exit the second adsorption unit 408 via the fourth outlet stream 412. Valve 422c may be moved to a closed position to restrict, or otherwise prevent, the desorbed constituents from passing through valve 422c and exiting the second adsorption unit 108 via the third output stream 410. When the adsorbent 414b adsorbs water, the fourth outlet stream 412 comprises water.

While the second adsorption vessel 412a operates in an adsorption cycle and the second adsorption vessel 412b operates in the regeneration cycle, the second adsorption vessel 412c may operate in a standby cycle. While operating in the standby cycle, valves 416e-416f are closed to restrict, or otherwise prevent, the flow of gas to the second adsorption vessel 412c. Valves 421c, 422e, and 432c are moved to the closed position to isolate the adsorbent 414c within the second adsorption vessel 412c. The second adsorption vessel 412c may remain in the standby mode until it is needed (e.g., maintenance needs to be performed on second adsorption vessels 412a-412b or the adsorbent 414a-414c needs to be replaced).

Once the adsorbent 414a has reached its adsorption capacity or a pre-determined adsorption timer has elapsed, the second adsorption vessel 412a may be transitioned from the adsorption cycle to a regeneration cycle. To transition from the adsorption cycle to the regeneration cycle, valves 416a and 416b are moved to the closed position to restrict, or otherwise prevent, the flow of the first gas stream 402 to the second adsorption vessel 412a, and valve 432a is opened to allow the regenerative gas stream 130 to enter the second adsorption vessel 412a and desorb the constituents from the adsorbent 414a. Further, during the transition, valve 422a is closed to restrict, or otherwise prevent, desorbed constituents from exiting the second adsorption unit 408 via the third output stream 410, and valve 422b is moved to the open position to allow desorbed constituents to exit the second adsorption unit 408 via the fourth output stream 412.

Once the adsorbent 414b has been regenerated or a pre-determined regeneration timer has elapsed, the second adsorption vessel 412b may be transitioned from the regeneration cycle to the adsorption cycle. To transition from the regeneration cycle to the adsorption cycle, valve 416c and valve 416d may be moved to the open position to allow the first gas stream 402 to enter the inlet 418b of the second adsorption vessel 412b, and valve 432b may be moved to the closed position to restrict, or otherwise prevent, the regeneration gas stream 130 from entering the inlet 418b. Constituents of the gas stream 402 that are not adsorbed by the adsorbent 414b are dispensed from the second adsorption vessel 412b via the outlet 420b. During the transition, valve 422d may be moved to the closed position to restrict, or otherwise prevent, constituents exiting the outlet 420b from passing through valve 422d and to the fourth output stream 412. During the transition, valve 422c may be moved to the open position to allow the constituents exiting the outlet 420b to pass through the valve 422c to the third output stream 410.

The output stream 410 comprising hydrogen sulfide and carbon dioxide is fed to the hydrogen sulfide adsorption unit 110, which is configured to generate output stream 124 that comprises carbon dioxide and an output stream 134 that comprises hydrogen sulfide, using the same or similar operation described in FIG. 2. The output stream 134 may be recycled to the sulfur recovery unit 104, as shown in FIGS. 2-3.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### EXAMPLES

### Example 1-Theoretical Chemistry Calculations Using Density Functional Theory (DFT)

For certain embodiments of the present disclosure, improved performance is obtained with adsorbents that show a strong H₂S adsorption and weak CO₂ and H₂O adsorption. All calculations were performed using plane-wave DFT employing Vanderbilt ultrasoft pseudopotentials. The QUANTUM ESPRESSO code and the BEEF-VdW exchange correlation functional were used for all calculations since utilizing this particular functional showed good performance in describing metal/adsorbates interactions. The plane-wave cutoff and density cutoff were 500 eV and 5000 eV, respectively. For all calculations, a 1×1×1 Monkhorst-Pack k-point sampling was used to model the Brillouin zone. Geometry optimizations were conducted with a quasi-Newton algorithm as implemented in the atomic simulation environment (ASE). The convergence criterion for structural optimization was a maximum force of 0.03 eV/Å per atom.

TABLE 1
DFT calculated Binding energy (eV) between the candidate
adsorbents and H₂S, CO₂ and H₂O molecules

| | H₂S | CO₂ | H₂O |
|---|---|---|---|
| Ca-exchange LTA | −1.24 | −0.94 | −1.08 |
| Sr-exchange LTA | −1.21 | −0.88 | −1.03 |
| Ba-exchange LTA | −1.16 | −0.74 | −0.92 |
| K-exchange LTA | −1.17 | −0.76 | −0.90 |
| Cu-exchanged LTA | −1.05 | −0.69 | −0.66 |
| Na-exchange LTA | −1.19 | −0.78 | −0.96 |
| Ba-exchange CHA | −1.33 | −0.35 | −0.48 |
| Be-exchange CHA | −0.96 | −0.54 | −1.76 |

What is claimed is:

1. A method comprising:
introducing a first gas stream to a hydrogen sulfide adsorption unit comprising an ion-exchanged zeolite, wherein the first gas stream comprises hydrogen sulfide and carbon dioxide;
generating a first outlet stream by separating the hydrogen sulfide from the carbon dioxide with the hydrogen sulfide adsorption unit, wherein the ion-exchanged zeolite is configured to adsorb at least a portion of the hydrogen sulfide from the first gas stream and allow the carbon dioxide to exit the hydrogen sulfide adsorption unit via the first outlet stream; and
desorbing the hydrogen sulfide from the ion-exchanged zeolite using a regeneration cycle, wherein during the regeneration cycle the hydrogen sulfide exits the hydrogen sulfide adsorption unit via a second outlet stream.

2. The method of claim 1, further comprising feeding the second outlet stream comprising the hydrogen sulfide to a sulfur recovery unit.

3. The method of claim 1, wherein the ion-exchanged zeolite comprises a cation-exchanged zeolite.

4. The method of claim 1, wherein the ion-exchanged zeolite is selected from the group consisting of an alkali metal-exchanged zeolite, an alkaline earth metal-exchanged zeolite, a transition metal-exchanged zeolite, and combinations thereof.

5. The method of claim 1, wherein the ion-exchanged zeolite has a framework selected from the group consisting of LTA and CHA.

6. The method of claim 1, wherein the ion-exchanged zeolite is selected from the group consisting of Ca-exchanged LTA, Sr-exchanged LTA, Ba-exchanged LTA, Na-exchanged LTA, Cu-exchanged LTA, K-exchanged LTA, and combinations thereof.

7. The method of claim 1, wherein the ion-exchanged zeolite is selected from the group consisting of Ba-exchanged CHA, Be-exchanged CHA, and combinations thereof.

8. The method of claim 1, wherein the first gas stream further comprises water; and
wherein generating the first outlet stream further comprises separating the hydrogen sulfide from the carbon dioxide and the water, wherein the ion-exchanged zeolite is configured to allow both the carbon dioxide and the water to exit the hydrogen sulfide adsorption unit via the first outlet gas stream.

9. The method of claim 1, wherein a water adsorption unit is positioned upstream of the hydrogen sulfide adsorption unit, and wherein the method further comprises:
receiving a second gas stream in the water adsorption unit, wherein the second gas stream comprises hydrogen sulfide, carbon dioxide, and water; and
separating the water from the hydrogen sulfide and the carbon dioxide with the water adsorption unit to generate a third outlet stream comprising water and the first gas stream comprising carbon dioxide and hydrogen sulfide.

10. A tail gas treatment system, the system comprising:
a hydrogen sulfide adsorption unit comprising at least one hydrogen sulfide adsorption vessel, wherein each hydrogen sulfide adsorption vessel comprises:
one or more inlets configured to receive a gas stream that comprises hydrogen sulfide and carbon dioxide;
an ion-exchanged zeolite positioned in the hydrogen sulfide adsorption vessel, wherein the ion-exchanged zeolite is configured to adsorb at least a portion of the hydrogen sulfide and allow the carbon dioxide to pass through the ion-exchanged zeolite;
one or more outlets configured to dispense the carbon dioxide from the hydrogen sulfide adsorption vessel during an adsorption cycle, wherein the one or more outlets are configured to dispense the hydrogen sulfide from the hydrogen sulfide adsorption vessel during a regeneration cycle;
a first valve positioned downstream of the one or more outlets, wherein during the adsorption cycle the first valve is moveable to an open position to allow the carbon dioxide to pass through the first valve and exit the hydrogen sulfide unit via a first output stream, and during the regeneration cycle the first valve is movable to a closed position to restrict hydrogen sulfide from passing through the first valve to the first output stream; and
a second valve positioned downstream of the one or more outlets, wherein during the adsorption cycle the second valve is movable to a closed position to restrict the carbon dioxide from passing through the second valve to a second output stream of the hydrogen sulfide adsorption unit, and during the regeneration cycle the second valve is movable to an open position to allow the hydrogen sulfide to pass through the second valve and exit the hydrogen sulfide unit via the second output stream.

11. The tail gas treatment system of claim 10, wherein the ion-exchanged zeolite comprises a cation-exchanged zeolite.

12. The tail gas treatment system of claim 10, wherein the ion-exchanged zeolite is selected from the group consisting of an alkali metal-exchanged zeolite, an alkaline earth metal-exchanged zeolite, a transition metal-exchanged zeolite, and combinations thereof.

13. The tail gas treatment system of claim 10, wherein the ion-exchanged zeolite has a framework selected from the group consisting of LTA and CHA.

14. The tail gas treatment system of claim 10, wherein the ion-exchanged zeolite is selected from the group consisting of Ca-exchanged LTA, Sr-exchanged LTA, Ba-exchanged LTA, Na-exchanged LTA, Cu-exchanged LTA, K-exchanged LTA, and combinations thereof.

15. The tail gas treatment system of claim 10, wherein the ion-exchanged zeolite is selected from the group consisting of Ba-exchanged CHA, Be-exchanged CHA, and combinations thereof.

16. The tail gas treatment system of claim 10, wherein the gas stream further comprises water; and
wherein the ion-exchanged zeolite is configured to allow both the carbon dioxide and the water to pass through the ion-exchanged zeolite and exit the hydrogen sulfide adsorption vessel via the one or more outlet during the adsorption cycle.

17. The tail gas treatment system of claim 10, wherein the tail gas treatment system further comprises:
a water adsorption unit positioned upstream of the inlet of the hydrogen sulfide adsorption vessel, wherein the water adsorption unit comprises at least one water adsorption vessel, wherein each water adsorption vessel comprises:
one or more inlet configured to receive the hydrogen sulfide, the carbon dioxide, and the water from a second gas stream;
an adsorbent positioned in the water adsorption vessel, the adsorbent configured to separate the water from the carbon dioxide and hydrogen sulfide; and
wherein the carbon dioxide and hydrogen sulfide are configured to exit the water adsorption unit via a third output stream, wherein the third output stream is fed to the hydrogen sulfide adsorption unit; and
wherein the water is configured to exit the water adsorption unit via a fourth output stream.

18. The tail gas treatment system of claim 11, further comprising:
a sulfur recovery unit comprising:
a first thermal stage comprising:
a combustion reactor configured to receive an air stream and an acid gas stream comprising hydrogen sulfide, wherein the combustion reactor is configured to combust the hydrogen sulfide with the oxygen in the air stream to generate a first outlet stream comprising sulfur, sulfur dioxide, water, and carbon dioxide;
a first stage condenser positioned downstream of the combustion reactor, wherein the first stage condenser is configured to transfer heat between the first outlet stream and a first coolant to generate a first sulfur stream and a second outlet stream;
a second catalytic stage comprising:
at least one catalytic reactor positioned downstream of the first stage sulfur condenser, the at least one catalytic reactor comprising a catalyst configured to react with hydrogen sulfide and sulfur dioxide from the second outlet stream to generate a third outlet stream comprising sulfur and water;
at least one second stage condenser positioned downstream of the at least one catalytic reactor, wherein the at least one second stage condenser is configured to transfer heat between the third outlet stream and a second coolant to generate a second sulfur stream and a tail gas stream comprising unreacted hydrogen sulfide, carbon dioxide, and water; and
wherein the hydrogen sulfide adsorption unit is positioned downstream of the sulfur recovery unit and configured to receive the hydrogen sulfide, the carbon dioxide, and the water; and
wherein the hydrogen sulfide adsorption vessel comprises a recycle stream that is in fluid communication with the second outlet of the hydrogen sulfide vessel and the combustion reactor of the sulfur recovery unit.
